(19) United States
(12) Patent Application Publication
(10) Pub. No.: US 2026/0145138 A1
(43) Pub. Date: May 28, 2026

(54) SPIRAL MEMBRANE ELEMENT

(71) Applicant: NITTO DENKO CORPORATION, Osaka (JP)

(72) Inventors: Yasuhiro UDA, Osaka (JP); Shinichi CHIKURA, Osaka (JP); Maya KIHARA, Osaka (JP); Seigo OGAWA, Osaka (JP)

(21) Appl. No.: 19/380,426

(22) Filed: Nov. 5, 2025

(30) Foreign Application Priority Data
Nov. 26, 2024 (JP) 2024-205417

(51) Int. Cl. B01D 63/10

(52) U.S. Cl. CPC B01D 63/107; B01D 63/1031; B01D 2313/042

(57) ABSTRACT

According to the present invention, a spiral membrane element in which the durability of a bonding part between a membrane leaf and a central pipe is improved, and the central pipe is more easily separated and collected at the time of recycling. The spiral membrane element includes: a plurality of membrane leaves each having a permeation-side flow-channel between separation membranes facing each other; and a perforated central pipe around which the membrane leaves are wound with a supply-side flow-channel interposed between the membrane leaves. The spiral membrane element includes a bonding part in which each of both-side ends in an axial direction among inner peripheral-side ends of the membrane leaves is bonded to the central pipe, and the central pipe includes a tapered part having a peripheral surface whose diameter expands toward a center side in the axial direction in at least a partial area of the bonding part.

### BACKGROUND OF THE INVENTION

### Field of the Invention

The present invention relates to a spiral membrane element (hereinafter, may be abbreviated as a “membrane element”) having a structure advantageous for recycling.

### Description of the Related Art

The spiral membrane element is produced, for example, by winding a plurality of membrane leaves in which a permeated water spacer is interposed between separation membranes facing each other and a feed water spacer around a central pipe, and applying fiber reinforced plastic (FRP) to the outer periphery thereof. An anti-telescoping device (ATD) attached to each of both ends is integrated during FRP construction. A U packing is attached to the ATD to prevent a bypass flow from occurring in a space between the element and the inner surface of a vessel. The membrane leaves are sealed at three sides to be in a liquid-tight state, and have a permeation-side flow-channel between the separation membranes facing each other.

Such a spiral membrane element inevitably deteriorates in performance over time because of deterioration over time and contamination of a membrane surface and the like due to its use. The contamination of the membrane surface can be recovered to a certain extent by increasing a feed water-side flow rate according to flushing cleaning to physically wash contaminants or chemically cleaning according to chemical cleaning, but this is also limited at some time, which requires the replacement of the element itself. Used membrane elements after replacement may be reused for other applications that do not require high performance, but most are discarded. Examples of the disposal method include landfill disposal and incineration disposal.

A method for treating the used membrane element has a major problem. The landfill disposal is not a sustainable treatment method because the volume of a treatable site is finite, and a membrane element most of which is a plastic material is not decomposed in the ground and thus semipermanently remains in the ground. Meanwhile, when the incineration disposal is performed, CO₂ which is a greenhouse gas is discharged, and thus there is a problem in terms of the global environment.

Therefore, it is desired to recycle the used membrane element as much as possible. For example, Patent Document 1 proposes, as a method for reusing a used spiral membrane element having a conventional structure, a method in which a separation functional layer of an RO membrane element is removed with an acid aqueous solution or the like and reproduced into a UF membrane which is a porous support.

A method for recycling a part of the used membrane element has also been proposed. For example, as a technique for reusing a central pipe (material recycling), Patent Document 2 proposes a fluid separation element in which a membrane unit including a separation membrane, a permeation liquid flow-channel member, and a raw liquid flow-channel member is formed around the central pipe, and an exterior body is formed outside the membrane unit, and a separator is interposed between the central pipe and the membrane unit. This separator is bonded to the membrane unit and attached to the central pipe so as to be simply in close contact with the peripheral surface thereof, so that the central pipe can be easily pulled out from the membrane unit and the separator and disassembled.

### PRIOR ART DOCUMENTS

### Patent Documents

Patent Document 1: JP-A-H11-156169
Patent Document 2: JP-A-H11-267467

### SUMMARY OF THE INVENTION

However, in the membrane element described in Patent Document 2, the separator is interposed between a membrane leaf and the central pipe, and thus it is difficult to ensure sufficient durability against a force applied in an axial direction, and there is a concern that the membrane leaf may be deformed due to positional deviation, resulting in the breakage of a sealing part.

Patent Document 2 also discloses that a tapered part having an outer diameter increasing from the upstream side to the downstream side is provided in the central pipe in order to prevent positional deviation due to a force in a raw liquid flow direction, but since an opposite direction force is generated in a bonding part between the sealing part on the downstream side of the membrane leaf and the central pipe, the positional deviation of the separator may be promoted in such a tapered part. That is, since the outside of the membrane leaf during operation has high pressure due to operation pressure, and the inside of the membrane leaf has low pressure on the permeation side, a force due to the differential pressure acts on the bonding part, and this force acts on the center side in the axial direction of the central pipe, so that the directions on the upstream side and the downstream side are opposite.

Incidentally, the membrane element is made of a plastic material derived from crude oil, which is a valuable fossil resource. The used membrane element can also be said to be a valuable carbon resource, and it is required to recycle the membrane element into the plastic material (chemical recycling).

Since the central pipe, which is a water collection pipe, is mainly in contact with permeated water, the membrane element after use is relatively less contaminated and suitable for recycling. However, since the central pipe is bonded and fixed to the membrane leaf at portions close to both ends, there is a problem that it takes time and cost to take out the central pipe. For this reason, a method capable of easily taking out the central pipe from the used membrane element and a structure therefor are required.

Therefore, an object of the present invention is to provide a spiral membrane element in which the durability of a bonding part between a membrane leaf and a central pipe is improved, and the central pipe is more easily separated and collected at the time of recycling.

The above object can be achieved by the present invention as described below.
[1] A spiral membrane element including: a plurality of membrane leaves each having a permeation-side flow-channel between separation membranes facing each other; and a perforated central pipe around which the membrane leaves are wound with a supply-side flow-channel interposed between any two of the membrane leaves, wherein
the spiral membrane element includes a bonding part in which each of both-side ends in an axial direction among inner peripheral-side ends of the membrane leaves is bonded to the central pipe, and
the central pipe includes a tapered part having a peripheral surface whose diameter expands toward a center side in the axial direction in at least a partial area of the bonding part.

According to the spiral membrane element of the present invention, the central pipe includes the tapered part having the peripheral surface whose diameter expands toward the center side in the axial direction in at least the partial area of the bonding part, and thus a force caused by differential pressure between operation pressure and permeation pressure, that is, a force applied to the center side of the central pipe becomes a force in a direction of pressing against a tapered surface, so that the risk of the bonding part peeling off can be reduced due to the differential pressure. When the central pipe includes the tapered part, the bonding part can be easily peeled off by applying a striking force or the like from an opposite direction end on the center side of the central pipe, and the central pipe is more easily separated and collected at the time of recycling. As a result, it is possible to provide the spiral membrane element in which the durability of the bonding part between the membrane leaf and the central pipe is improved, and the central pipe is more easily separated and collected at the time of recycling.
[2] The spiral membrane element according to [1], wherein the central pipe includes the tapered part having the peripheral surface whose diameter expands toward the center side in the axial direction in an entire area of the bonding part.

In the entire area of the bonding part, the central pipe includes the tapered part having the peripheral surface whose diameter expands toward the center side in the axial direction, so that the durability of the bonding part between the membrane leaf and the central pipe is improved in the entire bonding part on the upstream side and the downstream side, and the central pipe is more easily separated and collected at the time of recycling.
[3] The spiral membrane element according to [1] or [2], wherein a gradient θ of the tapered part satisfies tanθ=0.005 to 0.1.

When the gradient θ of the tapered part satisfies tanθ=0.005 to 0.1, it is not necessary to particularly change the shape of a conventional membrane leaf, and the effect of the tapered part can be sufficiently exhibited while the effective membrane area of the separation membrane to be filled is sufficiently maintained.
[4] The spiral membrane element according to any one of [1] to [3], wherein the central pipe has a divisible structure on the center side from the bonding part.

When the central pipe has the divisible structure on the center side from the bonding part, for example, when the both-end sealing parts of the membrane leaf are cut off in a recycling step, the membrane leaf around the central pipe is cut while the central pipe is left, whereby the end sides of the central pipe can be separated and collected from the central part of the central pipe without cutting the central pipe. For this reason, the end-side central pipe can be reused by being connected to the central part of the central pipe again.

According to the present invention, it is possible to provide a spiral membrane element in which the durability of a bonding part between a membrane leaf and a central pipe is improved, and the central pipe is more easily separated and collected at the time of recycling.

### BRIEF DESCRIPTION OF THE DRAWINGS

FIG. 1A is a partially exploded perspective view illustrating an example of a membrane element of the present invention;

FIG. 1B is a perspective view illustrating a main part obtained by cutting out a part of an example of the membrane element of the present invention;

FIG. 2 is a cross-sectional side view illustrating an example of the membrane element of the present invention;

FIG. 3A is a perspective view illustrating an example of a step of producing the membrane element of the present invention;

FIG. 3B is a perspective view illustrating an example of a step of producing the membrane element of the present invention;

FIG. 4A is a plan view illustrating an example of a step of cutting off both-side sealing parts;

FIG. 4B is a development view illustrating an example of a step of cutting off both-side sealing parts, which shows one of membrane leaves in a developed state;

FIG. 5 is a longitudinal sectional view illustrating an example of a step of separating and collecting a central pipe from the cut-off both-side sealing parts;

FIG. 6A is a cross-sectional side view illustrating another example of the membrane element of the present invention;

FIG. 6B is a longitudinal sectional view illustrating another example of a step of separating and collecting the central pipe from the cut-off both-side sealing parts;

FIG. 7A is a perspective view illustrating another example of the central pipe of the membrane element;

FIG. 7B is a perspective view illustrating another example of the central pipe of the membrane element;

FIG. 7C is a perspective view illustrating another example of the central pipe of the membrane element; and

FIG. 8 is a cross-sectional side view illustrating another example of the membrane element of the present invention.

### DETAILED DESCRIPTION OF THE PREFERRED EMBODIMENTS

### Spiral Membrane Element

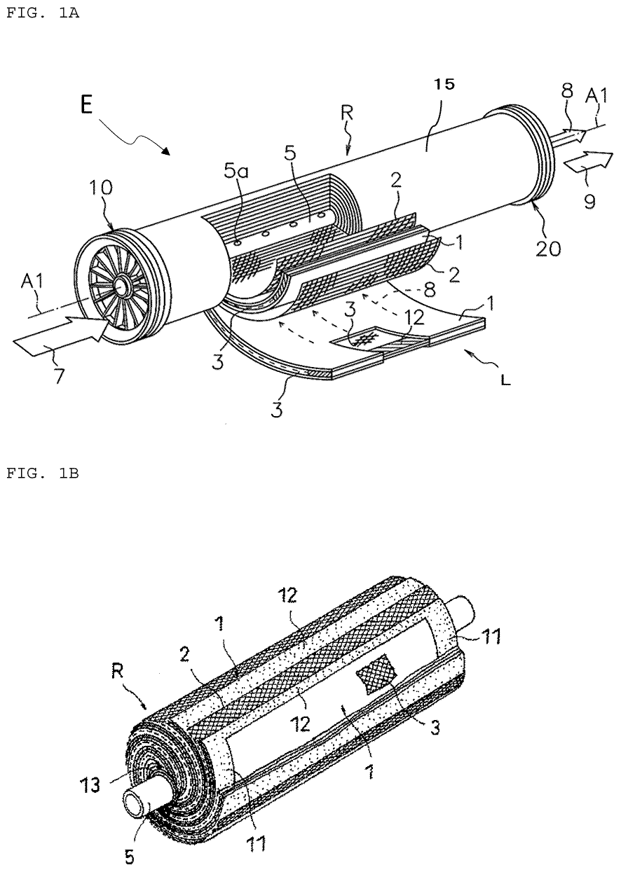

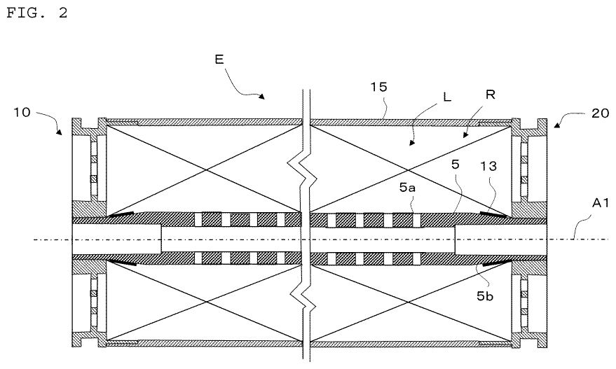

As illustrated in FIGS. 1A and 1B, a spiral membrane element E of the present invention includes a plurality of membrane leaves L each having a permeation-side flow-channel between separation membranes 1 facing each other, and a perforated central pipe 5 around which the membrane leaves L are wound with a supply-side flow-channel interposed between any two of the membrane leaves L. Usually, the permeation-side flow-channel is formed by a permeation-side spacer 3, and the supply-side flow-channel is formed by a supply-side spacer 2. The membrane leaf L generally has a structure in which three sides thereof are sealed together with the permeation-side spacer 3.

Therefore, the present embodiment illustrates an example of the used membrane element E including the plurality of membrane leaves L each having the permeation-side spacer 3 interposed between the separation membranes 1 facing each other and having both-side sealing parts 11 and a peripheral-side sealing part 12 that seal both-side ends and a peripheral-side end in an axial direction A1, the supply-side spacers 2 interposed between the membrane leaves L, and the perforated central pipe 5 around which the membrane leaves L and the supply-side spacers 2 are wound.

The membrane element E of the present invention has a structure advantageous for recycling the central pipe 5 when it becomes the used membrane element E, and can improve the durability of a bonding part 13 between the membrane leaf L and the central pipe 5 during operation.

Therefore, an example of an assumed recycling method will also be described. In the example of the recycling method to be described later, a method in which the permeation-side spacer 3 and the like included in the membrane leaf L can also be recycled in addition to the central pipe 5 is shown, but the present invention is not limited to the membrane element E that can be used only by such a recycling method.

The spiral membrane element E of the present invention may be described as the used membrane element E, but both the elements are the same. Examples of the used membrane element E include those in which the function as the membrane element E cannot be expected to be restored even if chemical cleaning or the like is performed.

In this specification, the membrane leaves L and the supply-side spacers 2 wound around the central pipe 5 are referred to as a roll R, and the membrane element E generally has a structure including an exterior member 15 around the outer periphery of the roll R as illustrated in FIG. 1A.

The membrane element E according to the present embodiment is provided with both-side sealing parts 11 and a peripheral-side sealing part 12 as sealing parts for preventing mixing of a supply-side flow-channel and a permeation-side flow-channel. As illustrated in FIG. 1B, the both-side sealing parts 11 among the sealing parts are obtained by using an adhesive to seal two side ends on both sides in the axial direction A1 of each of the membrane leaves L. The peripheral-side sealing part 12 is obtained by using an adhesive to seal ends of the peripheral-side tip of each of the membrane leaves L. An area surrounded by the separation membranes 1 facing each other, the both-side sealing parts 11, and the peripheral-side sealing part 12 serves as the permeation-side flow-channel. This communicates with openings 5a of the central pipe 5.

As illustrated in FIGS. 1B to 2, the membrane element E of the present invention includes the bonding part 13 in which each of both-side ends in the axial direction A1 of the inner peripheral-side end (base end) of each of the membrane leaves L is bonded to the central pipe 5, whereby the central pipe 5 and the base end of each of the membrane leaves L are sealed. In this example, the membrane element includes the roll R in which the membrane leaves L and the supply-side spacers 2 are wound around the central pipe 5 with such a bonding part 13 interposed therebetween. The adhesive for sealing is not particularly limited, and any conventionally known adhesive such as a urethane-based adhesive or an epoxy-based adhesive can be used.

In the general membrane element E, as illustrated in FIG. 1A, an upstream-side end member 10 such as a seal carrier is provided on the upstream side of the roll R, and a downstream-side end member 20 such as an anti-telescoping device is provided on the downstream side. The upstream-side end member 10 and the downstream-side end member 20 may be integrated with the roll R by winding FRP serving as the exterior member 15 around the outer periphery of the roll R.

In a typical spiral membrane element E having a diameter of 8 inches, about 15 to 30 sets of membrane leaves L are wound. When the membrane element E is used, the membrane element E is accommodated in a pressure vessel (vessel), and a supply liquid 7 is supplied from one end surface side of the membrane element E.

As illustrated in FIG. 1A, the supplied supply liquid 7 flows along the supply-side spacers 2 into a direction parallel with the axial direction A1 of the central pipe 5, and is then discharged as a concentrated liquid 9 from the other end surface side of the membrane element E. In the process in which the supply liquid 7 flows along the supply-side spacers 2, a permeation liquid 8 which has permeated through the separation membranes 1 flows along the permeation-side spacers 3, then flows into the central pipe 5 from the openings 5a, and is discharged from the end of the central pipe 5.

As illustrated in FIG. 2, the central pipe 5 in the present invention has the openings 5a. The central pipe 5 includes a tapered part 5b having a peripheral surface whose diameter expands toward the center side in the axial direction A1 in at least a partial area of the bonding part 13. In the illustrated example, the bonding part 13 is present on each of the upstream side and the downstream side, but can be provided on at least one of the upstream side and the downstream side. In any case, the total area of the tapered part 5b is preferably 10 to 200%, more preferably 50 to 150%, and still more preferably 80 to 120%, with respect to the total area of the bonding parts 13.

In the present embodiment, an example is shown, in which the central pipe 5 includes the tapered part 5b having the peripheral surface whose diameter expands toward the center side in the axial direction A1 in the entire area of the bonding parts 13. That is, an example is shown, in which the total area of the tapered part 5b is 100% or more with respect to the total area of the bonding parts 13 on the upstream side and the downstream side.

The gradient θ of the tapered part 5b preferably satisfies tanθ=0.005 to 0.1, and more preferably satisfies tanθ=0.01 to 0.035. The gradient θ refers to an angle θ formed between the surface of the tapered part 5b and the axial direction A1 in a cross section crossing the axial direction A1.

The peripheral surface of the tapered part 5b is not limited to a case where the cross-sectional shape is a straight line, and may be a polygonal line or a curved line including a plurality of line segments. However, from the viewpoint of improving the durability of the bonding part 13 and the separation and collection performance of the central pipe 5 at the time of recycling on average, the cross-sectional shape is preferably the straight line.

When the cross-sectional shape of the peripheral surface of the tapered part 5b is the polygonal line or the curved line, it is preferable that the cross-sectional shape is a polygonal line or a curved line in which an inclination angle monotonously increases in a diameter expansion direction. When the cross-sectional shape of the peripheral surface of the tapered part 5b is the polygonal line or the curved line, the gradient θ of a straight line connecting the start and end points of the tapered part 5b preferably satisfies tanθ=0.005 to 0.1, and more preferably satisfies tanθ=0.01 to 0.035.

The peripheral surface of the tapered part 5b may be subjected to surface treatment in order to adjust a peeling force from the bonding part 13. For example, in order to reduce the peeling force, the surface of the tapered part 5b may be modified, or a coating layer having higher releasability than that of the material constituting the central pipe 5 may be formed. The adjustment of such a peeling force may be performed at least in a part of the tapered part 5b, in the entire tapered part 5b, or on the entire length of the central pipe 5.

The supply-side spacer 2 generally has a function of ensuring spaces, the spaces being for uniformly supplying a fluid onto a membrane surface. The supply-side spacer 2 may be, for example, a net, a knitted fabric, or a sheet worked to have irregularities. Such a spacer that has a maximum thickness of about 0.1 to 3 mm can be appropriately used if necessary. The spacer is set on each of both surfaces of the separation membrane 1. Two different flow-channel members are generally used: one thereof is used, on the supply liquid side, as the supply-side spacer 2, and the other is used, on the permeation liquid side, as the permeation-side spacer 3. In the supply-side spacer 2, a thick network flow-channel member having large meshes is used, and in the permeation-side spacer 3, a woven fabric or knitted fabric flow-channel member having fine meshes is preferably used.

When an RO membrane or an NF membrane is used in applications such as seawater desalination and wastewater treatment, the permeation-side spacer 3 is interposed between the separation membranes 1 facing each other in the membrane leaves L as illustrated in FIG. 1A. The permeation-side spacer 3 is required to support the separation membranes 1 from the back sides of the membranes against pressure applied to the separation membranes 1, and further to ensure flow-channels for permeation liquid.

While the outside of the membrane leaves L during operation has high pressure due to the operation pressure, the inside of the membrane leaf L has low pressure on the permeation side. Therefore, a force due to the differential pressure acts on the bonding part 13, and this force acts on the center side in the axial direction A1 of the central pipe 5. In the present invention, also for the downstream-side bonding part 13, the central pipe 5 includes the tapered part 5b having the peripheral surface whose diameter expands toward the center side in the axial direction A1 in the area, and thus, a force caused by a differential pressure between the operation pressure and the permeation pressure, that is, a force applied to the center side of the central pipe 5 becomes a force in a direction of pressing against a tapered surface, so that the risk of the bonding part 13 peeling off can be reduced due to the differential pressure.

The permeation-side spacer 3 is preferably formed of a tricot knitted fabric in order to ensure the function as described above, and is more preferably a tricot knitted fabric subjected to resin impregnation reinforcement or fusion treatment after the formation of the knitted fabric.

As the separation membrane 1, various porous membranes can be used, but a composite semipermeable membrane including a separation functional layer on the surface of a porous support is preferable. The porous support preferably includes a polymer porous layer on one surface of a nonwoven fabric layer.

Such a composite semipermeable membrane is called an RO (reverse osmosis) membrane, an NF (nano-filtration) membrane, or an FO (forward osmosis) membrane depending on the filtration properties or treatment methods, and is usable for the production of ultrapure water, seawater desalination, desalinization of brackish water, and reuse of wastewater and the like.

Examples of the exterior member 15 include various sheets, films, and tapes, and if necessary, a fiber reinforced resin (FRP) or the like is used for reinforcement. In a structure in which the upstream-side end member 10 and the downstream-side end member 20 are firmly integrated by the exterior FRP, it is difficult to disassemble and collect the upstream-side end member 10 and the downstream-side end member 20. However, by cutting off the both-side sealing parts 11 at the time of recycling, these members are easily separated and collected.

### Production Method of Spiral Membrane Element

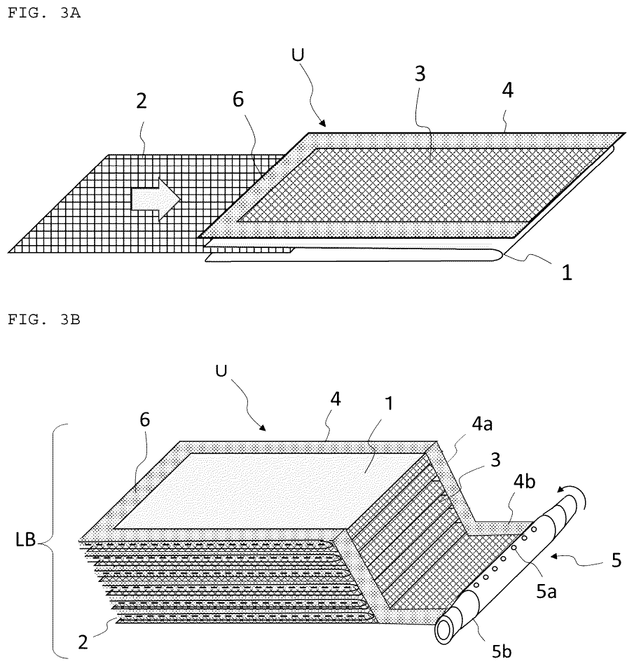

The membrane element as described above can be produced by a method similar to the conventional method. That is, for example, as illustrated in FIG. 3A, the permeation-side spacer 3 is placed on the separation membrane 1 with the supply-side spacer 2 interposed between the supply-side surfaces (separation functional layer side) of the separation membrane 1 folded in two such that the supply-side surfaces face each other, and a plurality of membrane units U are prepared in which an adhesive 4 for forming the both-side sealing parts 11 and an adhesive 6 for forming the peripheral-side sealing part 12 are applied to the permeation-side spacer 3.

Next, as illustrated in, for example, FIG. 3B, the membrane units U are laminated on the permeation-side spacer 3 having one end extended and fixed to the central pipe 5 according to the number of the membrane leaves L to form a laminate LB, and the laminate LB is wound around the central pipe 5. At this time, in only the uppermost membrane unit U, the adhesive 4 for forming the both-side sealing parts 11 and the adhesive 6 for forming the peripheral-side sealing part 12 are applied to the separation membrane 1 without placing the permeation-side spacer 3.

The adhesive 4a is applied so that the inner peripheral-side ends of the adhesive 4 of each of the membrane units U are continuous with each other, and the adhesive 4b is applied to both-side ends of the lowermost permeation-side spacer 3 so that the vicinity fixed to the central pipe 5 and the adhesive 4a are continuous with each other.

By holding the shape of the roll R after winding and curing the adhesive 4 and the like, the both-side sealing parts 11, the peripheral-side sealing part 12, and the bonding part 13 that seals the outer periphery of the central pipe 5 are formed. In particular, the bonding part 13 is mainly formed by the adhesive 4a and the adhesive 4b. As a result, the membrane element E is produced which includes the plurality of membrane leaves L each having the permeation-side flow-channel between the separation membranes 1 facing each other and the perforated central pipe 5 around which the membrane leaves L are wound with the supply-side flow-channel interposed between any two of the membrane leaves L.

The present invention is different from a conventional structure in that the central pipe 5 includes the tapered part 5b. However, as long as the gradient θ of the tapered part 5b is not particularly large, the membrane unit U does not need to be changed, and the conventional membrane unit U can be used as it is. At that time, in the vicinity of the tapered part 5b, the membrane unit U may be slightly deformed, but the deformation of the membrane unit U to such an extent that the separation function of the separation membrane 1 is impaired is less likely to occur. In this manner, in a state where the conventional membrane unit U is wound around the central pipe 5 including the tapered part 5b, the adhesive 4 and the like can be cured.

Next, if necessary, an upstream-side end member 10 such as a seal carrier can be attached to the end of the central pipe 5 on the upstream side of the roll R, and a downstream-side end member 20 such as an anti-telescoping device can be attached to the end of the central pipe 5 on the downstream side. An exterior member 15 can be provided around the outer periphery of the roll R. The upstream-side end member 10 and the downstream-side end member 20 can be integrated with the roll R by winding FRP serving as the exterior member 15 around the outer periphery of the roll R.

### Recycling Method

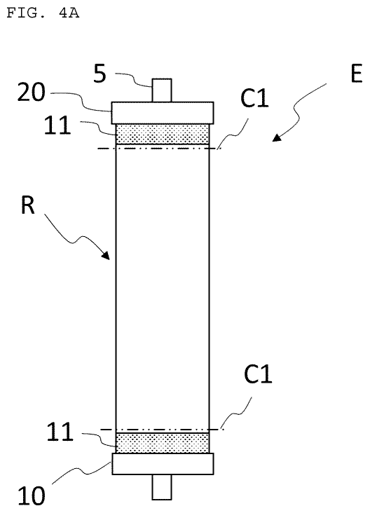

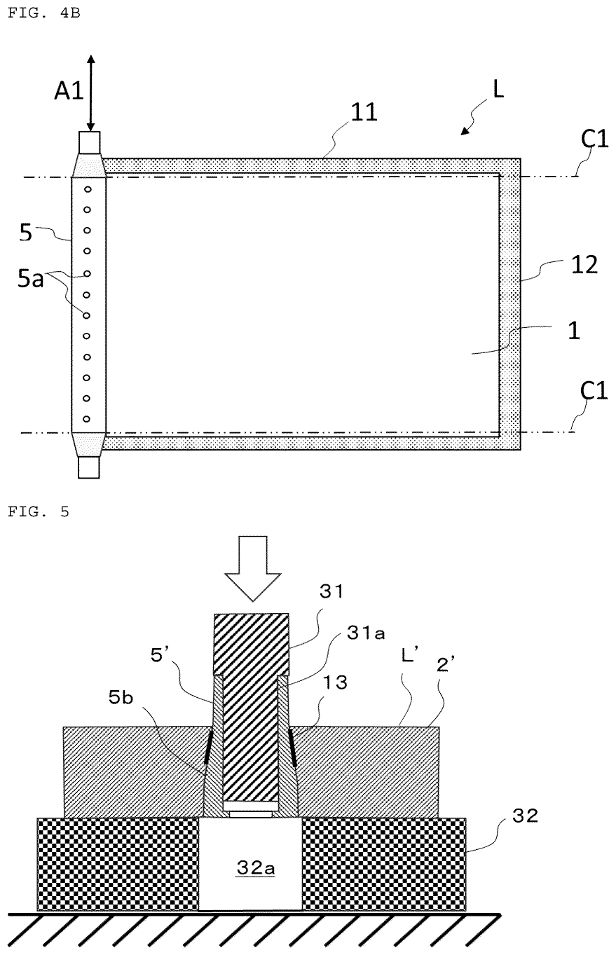

FIG. 4A is a plan view illustrating an example of a step of cutting off the both-side sealing parts 11, and FIG. 4B is a development view illustrating an example of the step of cutting off the both-side sealing parts 11, which shows one of the membrane leaves L in a developed state.

A method for recycling the membrane element E of the present invention can include a step of cutting off at least the both-side sealing parts 11 of the used membrane element E, for example, as illustrated in FIGS. 4A to 4B. Here, the both-side sealing parts 11 usually include the separation membranes 1 facing each other and the permeation-side spacer 3 interposed therebetween. In this step, as illustrated in FIG. 4A, both-side ends of the supply-side spacer 2 in the axial direction A1 are cut off when the both-side sealing parts 11 are cut off.

By this step, as illustrated in FIG. 5, the cut membrane leaf L′ and supply-side spacer 2′ are wound around a cut end-side central pipe 5′. Note that as illustrated in FIG. 5, the upstream-side end member 10 or the downstream-side end member 20 is removed after the both-side sealing parts 11 are cut off.

In this step, it is sufficient that at least the both-side sealing parts 11 are cut off from the main body of the membrane element E, and the end of the central pipe 5, the upstream-side end member 10, or the downstream-side end member 20 may be simultaneously cut off. That is, it is also possible to leave the ends without cutting the central pipe 5. In the present embodiment, an example is shown in which the both-side sealing parts 11, the both-side ends of the central pipe 5, the upstream-side end member 10, and the downstream-side end member 20 are cut off.

Examples of the method for cutting off the both-side sealing parts 11 include a method of removing both ends of the roll R including the both-side sealing parts 11 and both ends of the central pipe 5 from the main body of the membrane element E by cutting at a cutting line C1, a method of separating both ends of the roll R including the both-side sealing parts 11 from the main body of the membrane element E by cutting only the roll R without cutting the central pipe 5, and the like. Simultaneously or separately from these methods, it is also possible to remove the upstream-side end member 10 and the downstream-side end member 20.

The width at the time of cutting off the both-side sealing parts 11 of the used membrane element E is preferably 50 mm or less based on the length of the separation membrane 1 in the axial direction A1. In addition, it is preferable that the length of the separation membrane 1 after cut-off is 87% or more of the length before cut-off, based on the length of the separation membrane 1 before cut-off in the axial direction A1.

As illustrated in FIG. 5, the end-side central pipe 5′ can be easily peeled off from the bonding part 13 by applying a striking force or the like in the direction of an arrow, thereby removing the cut-off end part. Specifically, one of the cut-off ends is placed on a pedestal 32 having a hole 32a having a diameter slightly larger than the outer diameter of the central pipe 5, and a striking force is applied to a jig 31 in a state where the jig 31 is attached to the end-side central pipe 5′. At this time, the jig 31 only needs to have a structure capable of transmitting the striking force or the like to the central pipe 5′, but preferably includes an inner fitting part 31a inscribed in the inner peripheral surface of the central pipe 5′ in order to prevent the breakage of the central pipe 5′.

The bonding part 13 is bonded to the tapered part 5b whose diameter expands downward. By applying the striking force to the jig 31, a peeling force is generated at an interface between the central pipe 5′ and the bonding part 13, and thus the interface can be easily peeled off. Also for the other cut-off end, the end-side central pipe 5′ can be separated in the same manner. Since the separated and recovered end-side central pipe 5′ is an oil resource, it can be mainly used for chemical recycling.

Meanwhile, in the main body-side membrane leaf L after cutting off, the exterior member 15 is removed, and then the membrane leaf L is developed to cut off the peripheral-side sealing part 12, so that the members are easily separated, and the remaining parts of the permeation-side spacer 3, the supply-side spacer 2, and the central pipe 5 can be recycled.

### Other Embodiments

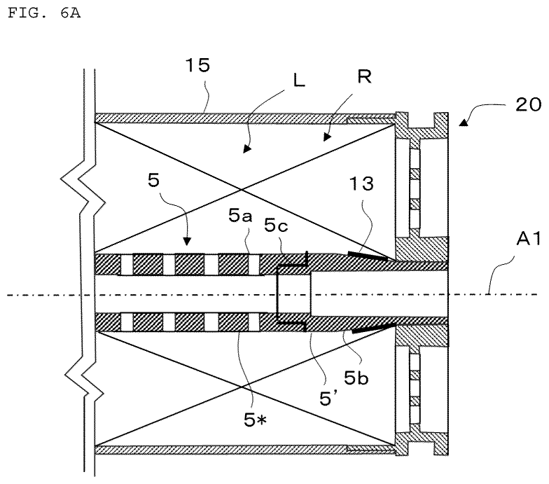

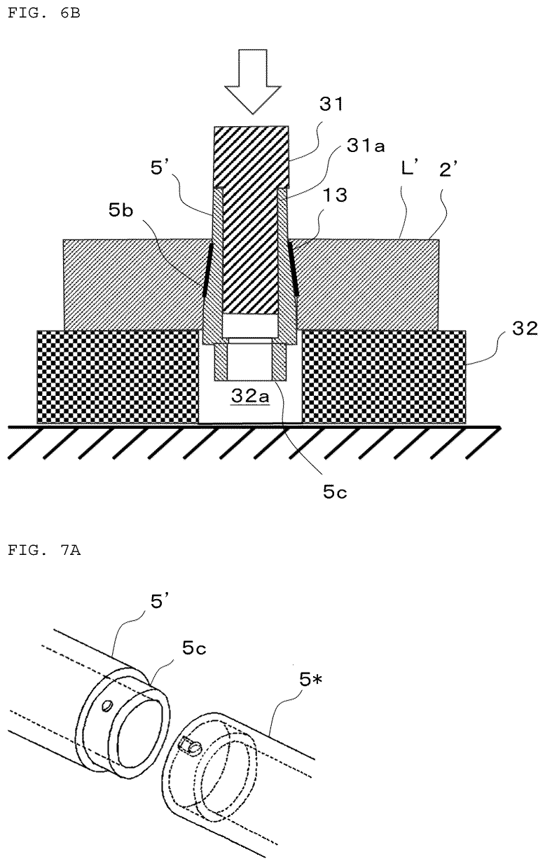

(1) In the above embodiment, an example has been described in which the central pipe 5 does not have a divisible structure. However, in the present invention, as illustrated in FIG. 6A, the central pipe 5 may have a divisible structure on the center side from the bonding part 13. In the illustrated example, the central pipe 5 includes a divisible fitting connection part 5c on a side near to the center from the bonding part 13 of the central pipe 5. A position where the divisible structure is provided is preferably on the center side from the bonding part 13 and on the outer side from an opening 5a provided at each of both ends of the central pipe 5.

When the central pipe 5 has a divisible structure, the end-side central pipe 5′ can be divided from the central part 5* of the central pipe 5 after cutting each of the both-side sealing parts 11 on a side near to the center thereof in a state where the both-side end parts of the central pipe 5 are left. Furthermore, as illustrated in FIG. 6B, the end-side central pipe 5′ can be separated and collected from the cut-off ends. Since the end-side central pipe 5′ can be connected to the central part 5* of the central pipe again, the end-side central pipe 5′ and the central part 5* of the central pipe can be reused.

Specifically, one of the cut-off ends is placed on a pedestal 32 having a hole 32a having a diameter slightly larger than the outer diameter of the central pipe 5, and a striking force is applied to a jig 31 in a state where the jig 31 is attached to the end-side central pipe 5′, whereby the divided end-side central pipe 5′ can be separated and collected.

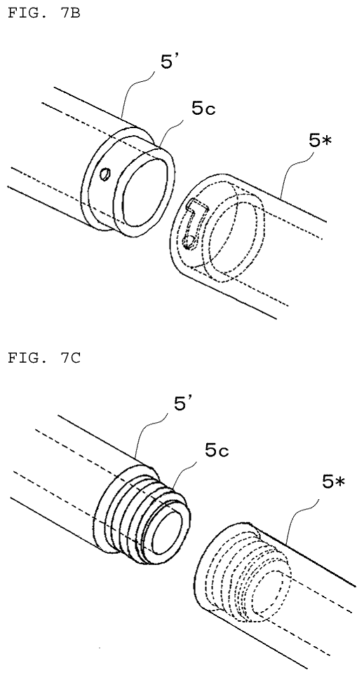

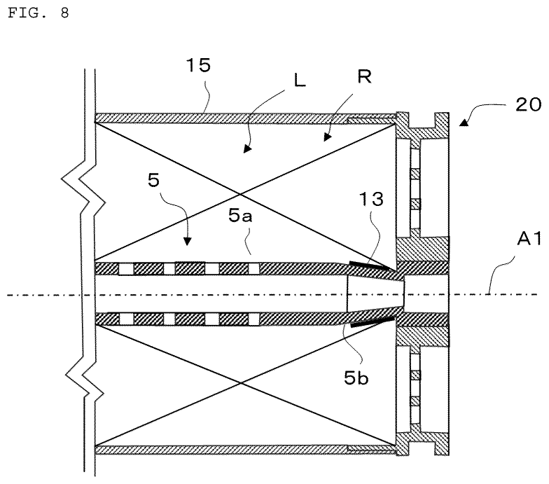

The divisible structure of the central pipe 5 is not particularly limited, but a fitting structure having a whirl-stop is preferable. FIGS. 7A to 7C illustrate examples of the fitting structure of the central pipe 5. In the example illustrated in FIG. 7A, the fitting connection part 5c of the end-side central pipe 5′ has a protrusion, and the central part 5* of the central pipe 5 has a guide groove and a recess. Therefore, the fitting connection part 5c can be pushed to lock the protrusion to the recess for fixing.

In the example illustrated in FIG. 7B, the fitting connection part 5c of the end-side central pipe 5′ has a protrusion, and the central part 5* of the central pipe 5 has an L-shaped guide groove and a recess. Therefore, when the fitting connection part 5c is pushed and rotated so that the protrusion follows the guide groove, the protrusion can be locked to the recess for fixing.

In the example illustrated in FIG. 7C, the fitting connection part 5c of the end-side central pipe 5′ has a male screw structure and the central part 5* of the central pipe 5 has a female screw structure. Therefore, the fitting connection part 5c can be rotated and screwed.
(2) In the above embodiment, the example in which the outer diameter of the main body part of the central pipe 5 is larger than the outer diameter of the distal end part of the central pipe 5 has been described. However, in the present invention, as illustrated in FIG. 8, the outer diameter of the main body part of the central pipe 5 may be equal to or smaller than the outer diameter of the distal end part of the central pipe 5.

In this case, by providing the tapered part 5b in the central pipe 5, an increase in the outer diameter of the main body of the central pipe 5 is suppressed, and by maintaining a volume for filling the separation membrane 1, a decrease in an effective membrane area can be suppressed.

Specifically, as illustrated in FIG. 8, while a stepped part having an outer diameter smaller than the outer diameter of the distal end part of the central pipe 5 is provided and a tapered part 5b having a peripheral surface whose diameter expands toward the center side in the axial direction A is formed starting from the stepped part, the tapered part 5b may have an outer diameter equal to or smaller than the outer diameter of the distal end part of the central pipe 5 at the end point of the tapered part 5b. That is, the central pipe 5 includes a distal pipe part, a stepped part that reduces the outer diameter of the distal pipe part, a tapered part 5b having a peripheral surface whose diameter expands from the stepped part toward the center side in the axial direction A, and a main body part continuous from the end point of the tapered part 5b and having an outer diameter equal to or smaller than the outer diameter of the distal pipe part.

Even in such a structure, the central pipe 5 includes the tapered part 5b having the peripheral surface whose diameter expands toward the center side in the axial direction A, and thus the bonding part 13 can be easily peeled off by cutting the distal end part of the central pipe 5 including the stepped part and then applying a striking force or the like from the side of the distal end part of the central pipe 5, and the central pipe 5 can be more easily separated and collected at the time of recycling.

The thickness of the tapered part 5b of the central pipe 5 can be ensured by shortening a fitting part for attaching an interconnector connecting the membrane elements E. In this case, the inner peripheral surface of the tapered part 5b of the central pipe 5 also preferably has a gradient similar to the gradient θ of the tapered part 5b.

### INDUSTRIAL APPLICABILITY

According to the present invention, it is possible to provide a spiral membrane element in which the durability of a bonding part between a membrane leaf and a central pipe is improved, and the central pipe is more easily separated and collected at the time of recycling. The central pipe can be recycled in a cut or divided state, can be subjected to chemical recycling or material recycling in the case of cutting, and can be reused in addition to that in the case of division. In either case, the central pipe is easily separated and recovered, and thus the spiral membrane element is useful as a spiral membrane element having a structure advantageous for recycling.

What is claimed is:

1. A spiral membrane element comprising:
a plurality of membrane leaves each having a permeation-side flow-channel between separation membranes facing each other; and
a perforated central pipe around which the membrane leaves are wound with a supply-side flow-channel interposed between any two of the membrane leaves,
wherein the spiral membrane element includes a bonding part in which each of both-side ends in an axial direction among inner peripheral-side ends of the membrane leaves is bonded to the central pipe, and
the central pipe includes a tapered part having a peripheral surface whose diameter expands toward a center side in the axial direction in at least a partial area of the bonding part.

2. The spiral membrane element according to claim 1, wherein the central pipe includes the tapered part having the peripheral surface whose diameter expands toward the center side in the axial direction in an entire area of the bonding part.

3. The spiral membrane element according to claim 1, wherein a gradient θ of the tapered part satisfies tanθ=0.005 to 0.1.

4. The spiral membrane element according to claim 1, wherein the central pipe has a divisible structure on the center side from the bonding part.
